(19) United States
(12) Patent Application Publication
(10) Pub. No.: US 2019/0184566 A1
(43) Pub. Date: Jun. 20, 2019

(54) ROBOT ARM, ROBOT CONTROL APPARATUS, AND ROBOT SYSTEM

(71) Applicant: CANON KABUSHIKI KAISHA, Tokyo (JP)

(72) Inventor: Akiyoshi Yokoi, Kawasaki-shi (JP)

(21) Appl. No.: 16/283,538

(22) Filed: Feb. 22, 2019

Related U.S. Application Data
(63) Continuation of application No. PCT/JP2017/030683, filed on Aug. 28, 2017.

(30) Foreign Application Priority Data
Sep. 28, 2016 (JP) 2016-190275

(51) Int. Cl. B25J 9/16; B25J 19/06

(52) U.S. Cl. CPC B25J 9/1694; B25J 9/1661; B25J 19/06

(57) ABSTRACT

When a main power supply is shut off and a robot control apparatus is unable to be involved, information on a state of each joint can be recorded at a robot arm alone. A robot arm includes: a plurality of links; a joint connecting the plurality of links to each other; and a sensor that detects a state of the joint. Further, the robot arm includes: a logging device that records output information of the sensor; and a powering unit that supplies power to the sensor and the logging device in a state where a drive power supply of the joint is shut off.

### CROSS-REFERENCE TO RELATED APPLICATIONS

This application is a Continuation of International Patent Application No. PCT/JP2017/030683, filed Aug. 28, 2017, which claims the benefit of Japanese Patent Application No. 2016-190275, filed Sep. 28, 2016, both of which are hereby incorporated by reference herein in their entirety.

### BACKGROUND OF THE INVENTION

### Field of the Invention

The present invention relates to a robot arm having a joint that connects a plurality of links to each other and a joint sensor that detects a state of the joint, a robot control apparatus used with the robot arm, and a robot system including the robot arm.

### Description of the Related Art

Conventionally, various robots have been used in production sites such as a factory. Recently, multi-joint robot arms for performing a more complex operation have been put into practical use and in wide-spread use. A motor and a reducer are mounted in a joint of such type of robot arms, and an excessive load applied to the joint may cause a failure.

One of the factors of an excessive load being applied to a joint of a robot arm may be vibration or impact applied to the robot arm in a non-operating state, in particular, during transportation or installation. Further, in an operating state, there may be a case where a robot arm comes into contact with other objects such as a structure, a workpiece, a tool, or the like.

In particular, in a non-operating state, one countermeasure against vibration or impact on a robot arm being transported may be, for example, a use of a transport box for packing which has a built-in impact recorder that measures an acceleration as disclosed in Japanese Patent No. 3366240 described below, though not dedicated to a robot arm. With the use of such a packing scheme for transportation of a robot arm, it is possible to accurately prove the presence or absence of impact during transportation, for example.

Further, with respect to vibration or impact on an operating robot arm, a joint angle detector may be provided to a joint of the arm, and a damage level of a reduction motor after an excessive load is applied may be measured, as disclosed in Japanese Patent Application Laid-Open No. 2015-3357, for example. According to the configuration of Japanese Patent Application Laid-Open No. 2015-3357, it is possible to measure a level of vibration, impact, or damage applied to a joint without disassembling a robot arm.

According to the scheme of Japanese Patent No. 3366240, it is possible to calculate a load applied to each joint by transporting a robot arm with a dedicated transport box and analyzing a recorded acceleration. However, Japanese Patent No. 3366240 illustrates a configuration of a general transport box, which does not directly detect vibration or impact applied to a targeted portion such as a joint of a robot arm, for example. It is therefore necessary to perform a process in which an acceleration of a position of the transport box at which a sensor is mounted is converted into a load on each joint of the robot arm, and it is not so easy to accurately perform such a conversion process. Further, since a dedicated vibration recorder device is needed, there is a problem of increase in transport cost.

Further, in the configuration of Japanese Patent Application Laid-Open No. 2015-3357, occurrence of an excessive load in a joint can be detected during an operation of a robot arm. However, at a timing when a main power supply is shut off and a robot control apparatus is unable to be involved, such as during transportation or during close of work hours at nighttime, for example, a load state of a joint cannot be detected. Thus, in a state during transportation or during close of work hours at nighttime, vibration or impact on an arm cannot be measured or recorded, it is difficult to prove the presence or absence of an excessive load of a non-operating period.

### SUMMARY OF THE INVENTION

Accordingly, the object of the present invention is to enable information on a state of each joint for a robot arm to be recorded at the robot arm alone at a timing when a main power supply is shut off and a robot control apparatus is unable to be involved, for example, such as during transportation or during close of work hours at nighttime.

To solve the object described above, in a configuration of a robot arm according to one aspect of the present invention, in a robot arm including a plurality of links; a joint connecting the plurality of links to each other; and a sensor that detects a state of the joint, a configuration including a logging device that records output information of the sensor; and a powering unit that supplies power to the sensor and the logging device in a state where a drive power supply of the joint is shut off is employed.

Further features of the present invention will become apparent from the following description of exemplary embodiments with reference to the attached drawings.

### BRIEF DESCRIPTION OF THE DRAWINGS

FIG. 1 is a perspective view illustrating a robot system according to a first embodiment.

FIG. 2 is a partial sectional view illustrating a joint of a robot arm of the robot system according to the first embodiment.

FIG. 3 is a block diagram illustrating a configuration of a control system of the robot system according to the first embodiment.

FIG. 4 is a function block diagram illustrating a primary configuration of the robot system according to the first embodiment.

FIG. 5 is a function block diagram illustrating a primary configuration of the robot system according to the first embodiment.

FIG. 6 is a graph illustrating change of the output shaft angle with respect to time according to the first embodiment.

FIG. 7 is a flowchart illustrating joint excessive load determination after connection of a control apparatus according to the first embodiment.

FIG. 8 is a schematic diagram illustrating a link of the robot arm in the first embodiment.

FIG. 9 is a graph illustrating fluctuation of the output shaft load with respect to time according to the first embodiment.

FIG. 10 is a partial sectional view illustrating a joint of a robot arm of the robot system according to a second embodiment.

FIG. 11 is a function block diagram illustrating a primary configuration of the robot system according to the second embodiment.

FIG. 12 is a flowchart illustrating joint excessive load determination after connection of a control apparatus according to the second embodiment.

FIG. 13 is a graph illustrating fluctuation of the output shaft load with respect to time according to the second embodiment.

### DESCRIPTION OF THE EMBODIMENTS

Embodiments for implementing the present invention will be described below with reference to the attached drawings. Note that the embodiment described below is a mere example, and those skilled in the art may appropriately change detailed configurations within a scope not departing from the spirit of the present invention, for example. Further, numerical values used in the embodiment are reference numerical values and are not intended to limit the present invention.

### First Embodiment

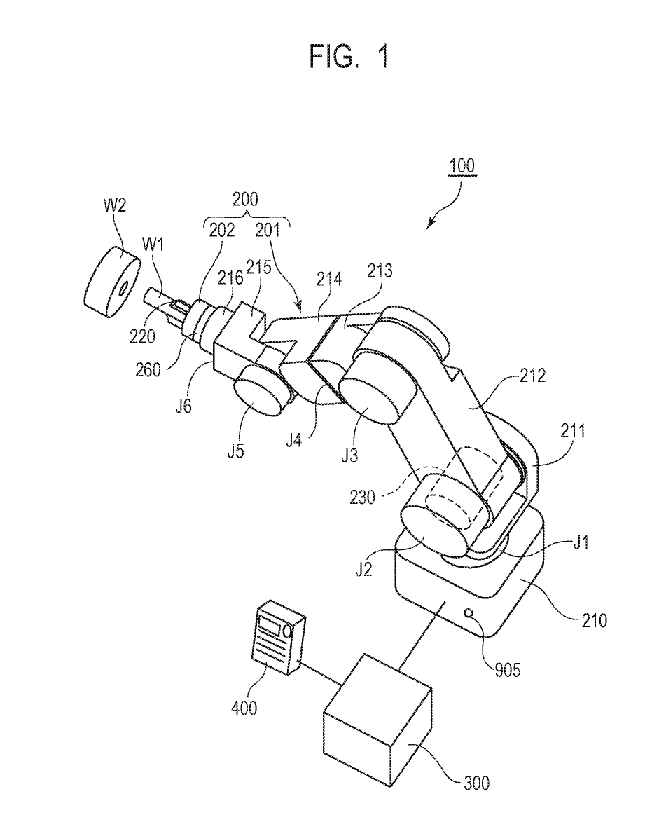

FIG. 1 is a perspective view illustrating the entire configuration of a robot system according to a first embodiment of the present invention. In FIG. 1, a robot system 100 has a robot arm unit 200 and a robot control apparatus 300 that controls the operation of the robot arm unit 200. Further, a teaching pendant 400 is connected to the robot control apparatus 300 as a teaching unit that teaches an operation of the robot arm unit 200 in accordance with a user operation.

The robot arm unit 200 has a vertical multi-joint robot arm 201 having joints with several axes (around two to six axes), for example, and a robot hand 202 attached to the tip of the robot arm 201 as an end effector.

The robot arm 201 forming a main portion of the robot arm unit 200 is coupled on a base portion 210 (base end link) fixed on a work stage such that a plurality of links 211 to 216 that transfer displacement or force can bend (pivot) or rotate at joints J1 to J6.

In the present embodiment, the robot arm 201 is formed of the joints J1 to J6 of six axes including three bending axes and three rotating axes. Here, bending refers to movement in which two links are bent at a certain point of a coupling part, and rotating refers to movement in which two links are relatively rotated about a rotation axis in the longitudinal direction of the two links, which are referred to as a bending portion and a rotating portion, respectively. In the case of the present embodiment, the robot arm 201 is formed of the six joints J1 to J6, in which the joints J1, J4, and J6 are rotating portions and the joints J2, J3, and J5 are bending portions, for example.

The robot hand 202 has a plurality of fingers 220 (or claws) and a hand base 221 and is attached to the tip of the robot arm 201, that is, to the tip of the link 216 (tip link) via a force sensor 260. The plurality of fingers 220 are supported by the hand base 221 so as to move inward or outward in a radial direction about a center axis relative to the hand base 221. By operating the plurality of fingers 220 to be closed, it is possible to hold a workpiece W1 (first workpiece), for example. Further, by operating the plurality of fingers 220 to be opened, it is possible to release the workpiece W1. The robot hand 202 can perform a fitting operation to fit the workpiece W1 (fitting component) into a workpiece W2 (fitted component: second workpiece) by holding the workpiece W1 by the plurality of fingers 220, for example.

The robot arm 201 has a plurality of (six) joint drive devices 230 provided to respective joints J1 to J6 and used for driving the joints J1 to J6, respectively. Note that, while only the joint drive device 230 for the joint J2 is illustrated in FIG. 1 for simplified illustration and depiction is omitted for other joints J1 and J3 to J6, the joint drive devices 230 having the same configuration are arranged for other joints J1 and J3 to J6.

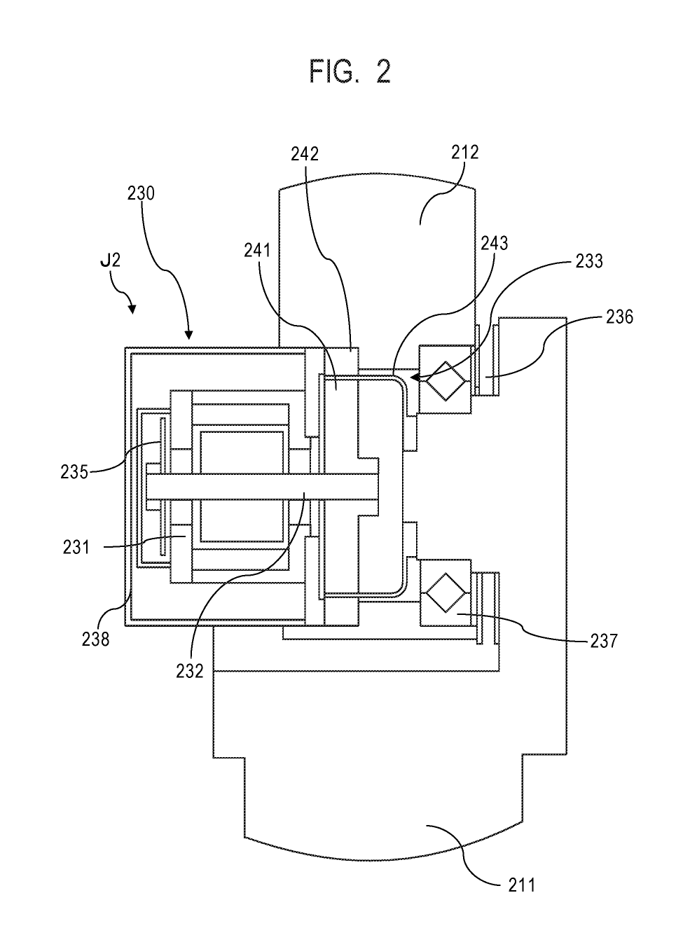

FIG. 2 is a partial sectional view illustrating the joint J2 of the robot arm 201. The structure of the joint J2 will be described below as the structure representing the structure of each of the joints J1 to J6, and the description for other joints J1 and J3 to J6 will be omitted because of the same configuration.

In FIG. 2, the joint drive device 230 has a rotary motor (hereafter, simply referred to as a motor) 231 and a reducer 233 that reduces the speed of rotation of a rotary shaft 232 of the motor 231.

The joint J2 has an encoder 235 (motor angle detection unit) that measures a rotation angle of the rotary shaft 232 (input shaft of the reducer 233) of the motor 231. Further, the joint J2 has an encoder 236 (joint angle detection unit) that measures an angle of the link 212 relative to the link 211 (a rotation angle of the output shaft of the reducer 233). The angle of the joint J2 (joint angle) is measured by the encoder 236.

The motor 231 is an electric motor that can be servo-controlled, for example, and can be formed of a brushless DC servo motor or an AC servo motor, for example.

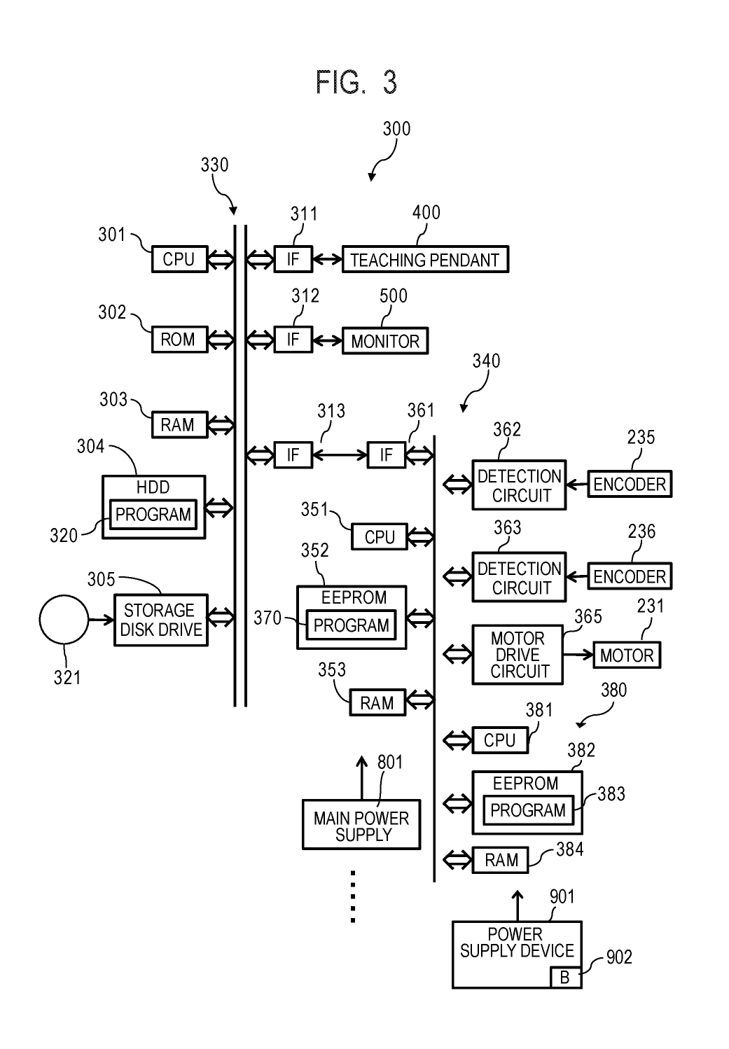

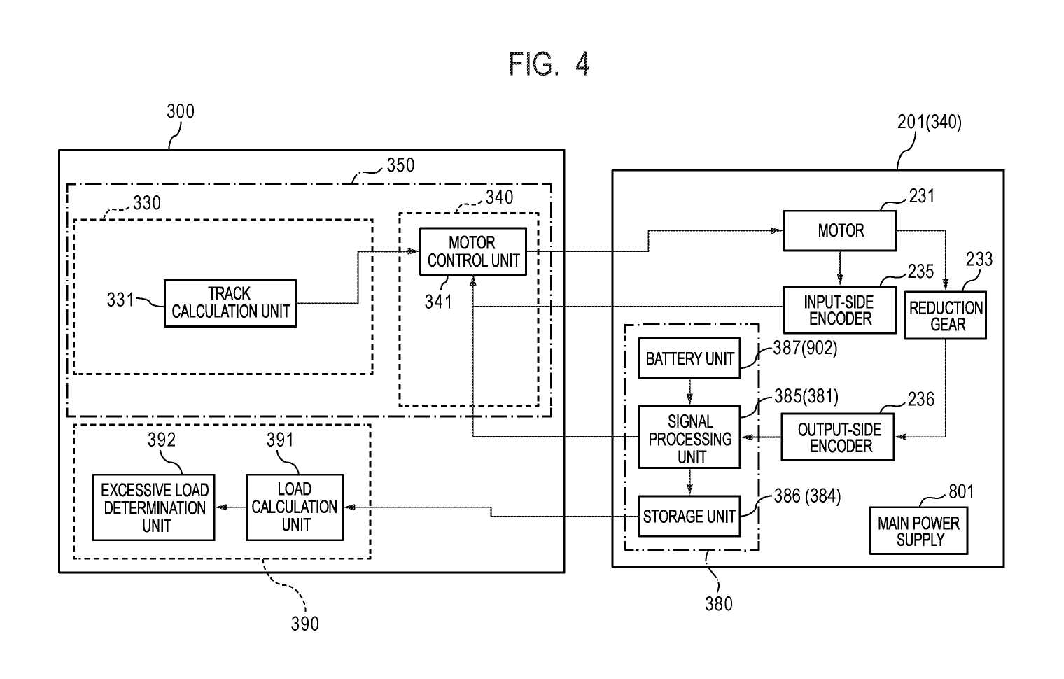

The encoder 235 is desirably an absolute type rotary encoder, for example. Although details are not depicted, the encoder 235 can be formed of an (absolute value) angle encoder of a single rotation, a counter of the total number of rotations of the (absolute value) angle encoder, a backup battery, which is a powering unit that supplies electric power to the counter, and the like. Further, the powering unit may be a member that accumulates externally supplied electric power. Even when power supply from a main power supply (801 in FIG. 3 and FIG. 4) to the robot arm 201 is turned off, the total number of rotations is held in the counter (not illustrated) of the encoder 235 as long as the backup battery is enabled regardless of whether power supply from the main power supply to the robot arm 201 is tuned on or off. Note that, while being attached to the rotary shaft 232 of the motor 231 in FIG. 2, the encoder 235 may be attached to the input shaft of the reducer 233.

Further, the encoder 236 is a rotary encoder that detects the relative angle between neighboring two links. In the joint J2, the encoder 236 is a rotary encoder that measures the relative angle between the link 211 and the link 212. While the encoder 236 may have a configuration (not illustrated in detail) in which an encoder scale is provided to the link 211 and a detection head is provided to the link 212, for example, the link on which the encoder scale is mounted and the link on which the detection head is mounted may be opposite. The link 211 and the link 212 are coupled so as to rotate freely via a cross roller bearing 237.

The motor 231 is covered with a motor cover 238 and protected. A brake unit (not illustrated) is provided between the motor 231 and the encoder 235. A primary function of the brake unit is to hold the attitude of the robot arm 201 when powered off.

The reducer 233 is formed of a compact and lightweight strain wave gearing reducer having a large reduction ratio, for example, in the present embodiment. The reducer 233 has a wave generator 241, which is an input shaft coupled to the rotary shaft 232 of the motor 231, and a circular spline 242, which is an output shaft fixed to the link 212. Note that, while directly coupled to the link 212, the circular spline 242 may be formed integrally with the link 212.

Further, the reducer 233 has a flex spline 243 arranged between the wave generator 241 and the circular spline 242 and fixed to the link 211. The flex spline 243 is slowed down at a reduction ratio N with respect to rotation of the wave generator 241 and rotates relatively to the circular spline 242. Therefore, the rotation of the rotary shaft 232 of the motor 231 is slowed down to the number of rotations of 1/N at the reducer 233, which causes the link 212 to which the circular spline 242 is fixed to pivot relatively to the link 211 to which the flex spline 243 is fixed and thereby causes the joint J2 to bend.

FIG. 3 is a block diagram illustrating a configuration of the control system of the robot system 100, in particular, the robot control apparatus 300 and a joint control unit 340 on the robot arm 201 side. In FIG. 3, the joint control unit 340 depicted on the right side of an interface 361 is accommodated inside a casing of the robot control apparatus 300 or inside a framework of the robot arm 201, for example.

The robot control apparatus 300 has a main control unit 330, a plurality of joint control units 340 (the number of which corresponds to the number of joints: six in the first embodiment), and an output shaft signal recorder unit 380.

The main control unit 330 is formed of a computer and has a CPU 301 as a calculation unit. Further, the main control unit 330 has a ROM 302, a RAM 303, and an HDD 304 as a storage unit. Further, the main control unit 330 has a storage disk drive 305 and various interfaces 311 to 313.

The ROM 302, the RAM 303, the HDD 304, the storage disk drive 305, and the various interfaces 311 to 313 are connected to the CPU 301 via a bus. A basic program such as BIOS has been stored in the ROM 302. The RAM 303 is a storage device that temporarily stores various data such as a calculation process result of the CPU 301.

The HDD 304 is a storage device that stores a calculation process result of the CPU 301, externally acquired various data, or the like and is also a device that stores a program 320 used for causing the CPU 301 to execute a calculation process described later. The CPU 301 performs each step of the robot control method based on the program 320 stored (stored or loaded) in the HDD 304.

The storage disk drive 305 can read various data, a program, or the like stored in the storage disk 321. Any storage form may be employed for the storage disk drive 305 and the storage disk 321, and the storage disk 321 may be, for example, an optical disk (CD(DVD)-R(OM)) or the like. Further, the name of “storage disk” is used for the purpose of illustration, and the storage disk 321 may be a semiconductor memory (disk) such as various flash memories widely used as storage devices. Note that an external storage device (not illustrated) such as a rewritable nonvolatile memory, an external HDD, or the like may be further connected to the main control unit 330.

The teaching pendant 400, which is a teaching unit, is connected to the interface 311. The teaching pendant 400 designates a teaching point that teaches the robot arm unit 200, that is, target joint angles of respective joints J1 to J6 (target rotation positons of the motors 231 of respective joints J1 to J6) in accordance with a user input operation. The data of a teaching point is output to the HDD 304 through the interface 311 and the bus.

The HDD 304 can load data of a teaching point designated by the teaching pendant 400. The CPU 301 can read data of the teaching point set (stored or loaded) in the HDD 304.

A monitor 500 (display device), which is a display unit, is connected to the interface 312 and can display a setting state or a control state of the robot system 100, for example, in a form of a text or an image based on control of the CPU 301. With the use of the monitor 500, information on the state of each joint of the robot arm 201 logged as described later or information on the load on each joint acquired based thereon can be displayed.

The joint control unit 340 is connected to the interface 313. While the robot arm 201 has six joints J1 to J6 and the robot control apparatus 300 has six joint control units 340 accordingly in the present embodiment, only one of the joint control units 340 is depicted in FIG. 3, and the illustration of the remaining five is omitted. Each of the joint control units 340 is arranged inside the casing of the robot control apparatus 300, for example. Note that the arrangement position of the joint control unit 340 is not limited to the inside of the casing but may be arranged in the robot arm 201, for example.

The CPU 301 calculates the track of the robot arm 201 based on the preset teaching point and outputs a position instruction signal indicating a target rotation position (a control amount of a rotation angle) of the rotary shaft 232 of the motor 231 to each joint control unit 340 at a predetermined time interval.

The joint control unit 340 has a CPU 351, an EEPROM 352 and a RAM 353 as storage units, an interface 361, detection circuits 362 and 363, and a motor drive circuit 365, and these components are connected via a bus. The CPU 351 executes a calculation process in accordance with a program 370. The EEPROM 352 is a storage device that stores the program 370. The RAM 353 is a storage device that temporarily stores various data such as a calculation process result of the CPU 351.

The main control unit 330 described above has a plurality of (six) interfaces 313 (only one of the interfaces 313 is illustrated in FIG. 3). The interfaces 313 and the interfaces 361 of the joint control units 340 of respective joints (J1 to J6) are connected by the cable or the like, and a signal can be transmitted and received between the main control unit 330 and each of the joint control units 340.

The encoder 235 described above is connected to the detection circuit 362, and the encoder 236 is connected to the detection circuit 363. A pulse signal indicating a measured angle detection value is output from each of the encoders 235 and 236. The detection circuits 362 and 363 acquire the pulse signals from the encoders 235 and 236, convert the pulse signals into a signal that can be acquired by the CPU 351, and output the signal to the CPU 351.

The motor drive circuit 365 is a motor driver having a semiconductor switching element, for example, which outputs a pulse-width-modulated three-phase AC PWM waveform voltage to the motor 231 in accordance with an input current instruction and thereby supplies a current to the motor 231.

The CPU 351 of the joint control unit 340 calculates a current output amount (current instruction) supplied to the motor 231 so that the rotation position (rotation angle) of the motor 231 approaches the instructed position input from the CPU 301 of the main control unit 330 and outputs the current instruction to the motor drive circuit 365.

The motor drive circuit 365 supplies a current corresponding to the input current instruction to the motor 231. The motor 231 then generates a drive torque in response to power supply from the motor drive circuit 365 and transfers the torque to the wave generator 241, which is the input shaft of the reducer 233. In the reducer 233, the circular spline 242, which is the output shaft, rotates at the number of rotations of 1/N relative to the rotation of the wave generator 241. Thereby, the link 212 rotates relatively with respect to the link 211.

As discussed above, the joint control unit 340 of each of the joints (J1 to J6) supplies a current to the motor 231 so that the rotation position of the motor 231 approaches the instructed position input from the main control unit 330 to control the joint angle of each of the joints J1 to J6.

Note that the CPU 351, the EEPROM 352, and the RAM 353 of the joint control unit 340 may be arranged for each joint as described above. However, only one set of the above may be arranged as control on the robot arm 201 side that integrally controls the entire joint control unit 340 of each of the joints (J1 to J6).

As described above, the robot control apparatus 300 uses the main control unit 330 and the joint control unit 340 and executes the programs 320 and 370, which are operation programs, to operate the robot arm 201.

Each control unit on the robot arm 201 side described above basically operates by the main power supply 801. While the power supply unit of the robot arm 201 is illustrated here by a conceptual block as the main power supply 801, several different forms may be considered as the specific configuration thereof. For example, the main power supply 801 may be configured to be supplied with DC power from the robot control apparatus 300 side by a power supply line included in the interface 361. Further, the main power supply 801 may be configured by using a power supply unit that transforms and stabilizes a commercial power supply. In any cases, however, power supply from the main power supply 801 to each control unit on the robot arm 201 side described above can be turned on or shut off by the control of the robot control apparatus 300. Further, in a configuration in which the main power supply 801 is supplied from the robot control apparatus 300 side in particular, power supply from the main power supply 801 is shut off when the robot arm 201 and the robot control apparatus 300 are disconnected from each other during transportation or the like. Further, in a state where power supply from the main power supply 801 is shut off, the motor 231, which is a drive source of each of the joints (J1 to J6), is obviously unable to be powered, and driving of the motor 231, that is, joint driving is unable to be performed. In terms of the above, in other words, the main power supply 801 can be considered as “drive power supply” that drives (each of) joint parts of the robot arm 201.

On the other hand, in the present embodiment, the output shaft signal recorder unit 380 is arranged to the robot arm 201 so as to be able to log (record) the state of each of the joints (J1 to J6) (the joint angle in the present embodiment) in a state where power supply from the main power supply 801 (drive power supply of the joint) is shut off. The output shaft signal recorder unit 380 has a CPU 381 and an EEPROM 382 and a RAM 384 as storage units.

The CPU 381 of the output shaft signal recorder unit 380 performs acquisition of output shaft information detected from the encoders 235 and 236 in accordance with an acquisition program 383. The EEPROM 382 forms a storage device that stores the acquisition program 383. The RAM 384 is a storage device that temporarily stores output shaft data acquired by the CPU 381.

The output shaft signal recorder unit 380 as a logging device is configured to be able to operate with a power supply device 901 even in a state where a main power supply (801) supplied to a drive source of a joint (the motor 231) is shut off. In a state where the main power supply (801) is shut off, the power supply device 901 supplies power of a battery 902, which is a powering unit, to the CPU 381, the EEPROM 382, and the RAM 384 to operate the output shaft signal recorder unit 380 as a logging device.

The output shaft signal recorder unit 380 forms a logging device that records (logs) an output value of the joint sensor (the encoders 235 and 236 in the present embodiment) in the storage device (for example, the RAM 384) in association with clock information. For example, a device such as a real time clock (RTC) is arranged in the output shaft signal recorder unit 380. Further, output information acquired from the joint sensor and the clock information of the RTC at the time of acquisition are stored in the storage device (for example, the RAM 384) in association with a particular storage format. Alternatively, a scheme in which output information is acquired from the joint sensor in synchronization with the clock of the CPU 381 and sequentially stored in the storage device (for example, the RAM 384) may be employed. In such a case, with the start time or the like of a logging process being recorded in the head of log information or the like, it is possible to determine the time of an output event of the joint sensor in a load measurement (evaluation) process or the like described later. Further, when start of logging is instructed from the robot control apparatus 300 side, the log start time may be recorded on the robot control apparatus 300 side and used in the load measurement (evaluation) process described later. As discussed above, any scheme of associating output information from the joint sensor with clock information may be employed.

Note that, in the description below, the joint sensor used for recording output may be the encoder 236 on the output shaft side of the reducer 233 (or the joint). Thus, the output of the joint sensor is considered as “output shaft signal”, and the name of the output shaft signal recorder unit 380 is used as a logging device. Further, as the storage device used for recording (logging) the output value of the joint sensor in association with clock information, not only the RAM 384 (backed up by the battery 902) but also the EEPROM 382 or the like may be used.

Note that, while a case where a computer readable storage medium is the HDD 304 or the EEPROM 352 and the programs 320 and 370 are stored in the HDD 304 or the EEPROM 352 will be described in the present embodiment, the configuration is not limited thereto. For example, the programs 320 and 370 may be stored in any storage medium as long as it is a computer readable storage medium. For example, as a storage medium used for supplying the programs 320 and 370, the storage disk 321 illustrated in FIG. 3, an external storage device (not illustrated), or the like may be used. As specific examples, a flexible disk, a hard disk, an optical disk, a magneto-optical disk, a CD-ROM, a CD-R, a magnetic tape, a nonvolatile memory, a ROM, or the like may be used as a storage medium. When a control program describing a control procedure performed by the robot arm 201 or the robot control apparatus 300 described later is stored in such a computer readable storage medium, such a storage medium will configure the storage medium used for the control program of the present invention.

FIG. 4 illustrates a configuration according to the function of the control system of FIG. 3 as a function block diagram. In FIG. 4, the function of the CPU 301 based on the program 320 is illustrated as a block, and the function of the CPU 351 and the function of the motor drive circuit 365 based on the program 370 are illustrated as blocks. In the robot arm unit 200, the joint J1 of the robot arm 201 is illustrated as a block, and the function of the CPU 381 based on the acquisition program 383 is illustrated as a block. Further, while a different name and a different reference are used in FIG. 4 for a component corresponding to the component of FIG. 3 in terms of the function for the purpose of illustration, each correspondence between both the figures is indicated by a parenthesis with the reference numeral used in FIG. 3 with respect to the reference numeral corresponding to the component of FIG. 3.

The robot control apparatus 300 has the function of the main control unit 330 and the joint control unit 340 corresponding to each of the joints J1 to J6, which are the first control unit 350, and a load processing unit 390 of the output shaft. The load processing unit 390 also has the function of acquiring log information in the storage unit 386 from the robot arm 201 side, and in this sense, the load processing unit 390 can be considered as a log acquisition device. FIG. 4 illustrates only the joint J1 and the joint control unit 340 corresponding to the joint J1, and although illustration is omitted, the robot control apparatus 300 integrally controls multiple ones of the joint control units 340 corresponding to other joints J2 to J6, respectively.

The main control unit 330 has a track calculation unit 331, and each joint control unit 340 has a motor control unit 341. The CPU 301 of the main control unit 330 functions as the track calculation unit 331 with the program 320.

Further, the motor control unit 341 of each of the joint control units 340 corresponds to the function of the CPU 351 and the motor drive circuit 365 operated by the program 370. Each of the joint control units 340 corresponds to the function of the CPU 351 operated by the program 370.

The control operation of the main control unit 330 will now be described. The track calculation unit 331 calculates movement (track) of the robot arm 201 based on data of a teaching point. The teaching point is set as a point in a joint space or a task space by the teaching pendant 400 operated by an operator.

Parameters representing flexibility of the robot arm 201 are defined as joint angles, and the joint angle of the joints J1 to J6 of the robot arm 201 are denoted as θ1 to θ6, respectively. The configuration of the robot arm 201 is denoted as (θ1, θ2, θ3, θ4, θ5, θ6) and can be considered as a single point in the joint space. In such a way, when the parameter representing flexibility of the robot arm 201 (for example, a joint angle or an expansion length) is denoted as a value on the coordinate axis, the configuration of the robot arm 201 can be expressed as a point in the joint space. In this way, the joint space is a space whose coordinate axis defines the joint angle of the robot arm 201.

The track calculation unit 331 generates a path of the robot arm 201 that connects a plurality of set teaching points by using a predetermined interpolation method (for example, linear interpolation, arc interpolation, joint interpolation, or the like). The track calculation unit 331 then generates a track of the robot arm 201 from the generated path of the robot arm 201.

The path of the robot arm 201 here is a sequence set of points in a joint space or a task space. The track of the robot arm 201 represents a path using time as a parameter and, in the present embodiment, is a set of instructed positions of the motors 231 of respective joints J1 to J6 for each time.

The track data is calculated in advance before the robot arm 201 is operated and is pre-stored (preset) in a storage unit, for example, the HDD 304. Note that, while a case where the calculation of track data is performed by the CPU 301 of the main control unit 330 is described, a configuration in which track data may be calculated by another computer (not illustrated) and pre-stored (preset) in the storage unit, for example, the HDD 304 of the main control unit 330 may be employed.

Next, each of the joint control units 340 will be described. The motor control unit 341 is input with a position instruction from the track calculation unit 331. The position instruction from the track calculation unit 331 is a position instruction calculated based on the teaching point as described above. The motor control unit 341 references the input position instruction and the value of the encoder 235 and performs position control (feedback control) of the motor 231 so that the rotation position of the motor 231 approaches the instructed position.

Further, the motor 231 of the joint drive device 230, the reducer 233, the encoders 235 and 236, and the output shaft signal recorder unit 380, which is the second control unit, are arranged in the joint of the robot arm 201. The output shaft signal recorder unit 380 is formed of a signal processing unit 385 that processes a signal of the output-side encoder 236 and a battery unit 387, which is a powering unit that actuates the storage unit 386 that stores the processed data. The output-side encoder 236, the storage unit 386, and the battery unit 387 can be integrally formed on the same circuit substrate, for example.

The output shaft signal recorder unit 380 performs only the output signal process and the recording process of the encoder 235 or 236, has no motor control function for controlling the motor 231, and thus does not require a large power and consumes power around a few watts. Thus, the battery unit 387 that powers and drives the output shaft signal recorder unit 380 may be a compact battery or capacitor and therefore can be easily implemented in the space inside the body of the robot arm 201. Note that the battery unit 387 may also serve as a backup battery of the encoder described above.

Further, by using a connector or the like of the robot arm 201 used for being connected to the robot control apparatus 300, a configuration in which an external powering unit, an external battery, or an external storage circuit corresponding to the battery unit 387 and the output shaft signal recorder unit 380 described above can be externally attached may be employed. Such a configuration provides a possibility of using a large-capacity external battery or a large-capacity external recorder circuit for recording of the joint output shaft signal, for example, which enables a long term logging (recording) operation.

As described above, in the present embodiment, the output shaft signal recorder unit 380 and the battery unit 283, which is a powering unit, are implemented inside the robot arm 201. Thus, even in a state where the main control unit 330 is not connected, the output shaft signal recorder unit 380 can acquire and record (log) the output shaft signal in the storage unit 386. That is, even when a robot arm (unit) is in a non-operating state such as transportation or installation, information on the output shaft can be recorded (logged).

Next, the load processing unit 390 of the output shaft will be described. The load processing unit 390 of the output shaft is provided in the robot control apparatus 300. The load processing unit 390 has a load calculation unit 391 that extracts output shaft information stored in the storage unit 386 described above and calculates the load applied to a joint, for example, the reducer 233 and an excessive load determination unit 392 that determines an excessive load from a load calculation result.

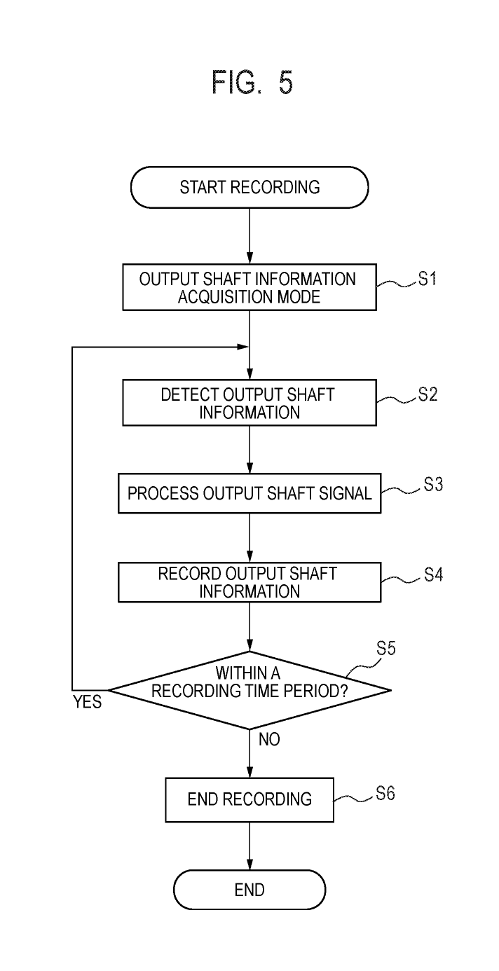

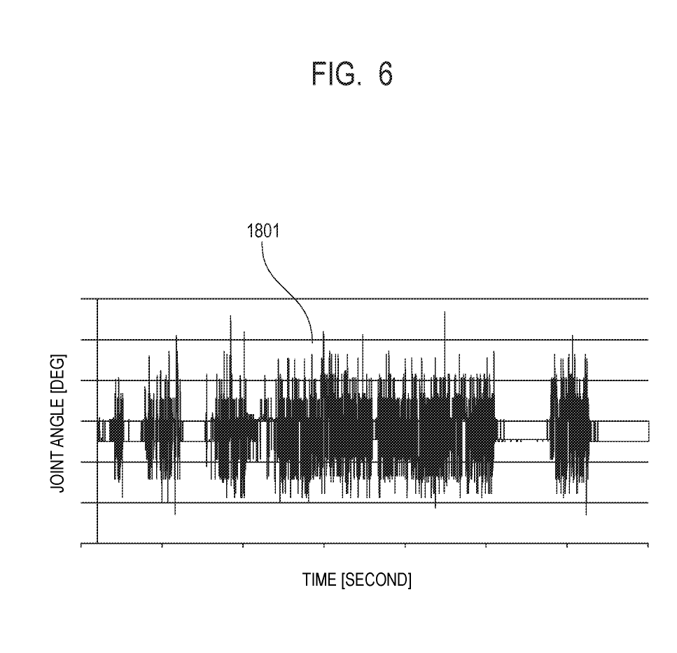

Next, an output shaft information acquisition (logging) mode of the robot arm 201 will be described. FIG. 5 is a flowchart illustrating a control procedure of output shaft information acquisition according to the present embodiment, and FIG. 6 is a graph of output shaft information.

In the present embodiment, in step S1 of FIG. 5, the output shaft information acquisition (logging) mode of the CPU 381 is enabled. This output shaft information recording mode is intended to be enabled in a period in which an excessive load is likely to be applied to the reducer 233 of the robot arm 201 during transportation, an installation operation, or the like. The output shaft information recording mode is a mode that can be activated by the hardware configuration of the robot arm 201 described above even when the robot control apparatus 300 is not connected.

Further, the output shaft information recording mode can be utilized not only during an operation of transportation or installation but also in a state where the main power supply (801) is activated even though not connected to the robot control apparatus 300 via a cable or the like such as close of work hours at nighttime. That is, this mode is to power the output shaft signal recorder unit 380 (logging device) with the power of the battery unit 283 to perform logging in a state where power supply from the main power supply (801) to the drive source (the motor 231) of a joint of the robot arm 201 is shut off.

A method of transferring to the output shaft information recording mode may be transfer caused by operating the teaching pendant 400 connected to the robot control apparatus 300 or transfer caused by a timer operation or a trigger operation with a threshold. This “trigger operation with a threshold” includes, for example, a scheme of triggering the mode in response to electrical disconnection of the connection between the robot control apparatus 300 and the robot arm 201 via a level or the like of a particular signal line connecting the robot control apparatus 300 and the robot arm 201. Further, as another method, a personal computer or the like used for inspection may be connected to the connection connector of the robot control apparatus 300 to enable acquisition mode transfer or various setting to be performed.

Further, while the configuration of connecting a personal computer or the robot control apparatus 300 has been described in the present embodiment, an operating switch or a display (for example, 905 of FIG. 1) may be provided to the robot arm 201 to enable transfer by using only the robot arm 201. In such a case, the output shaft information recording mode can be started by only the operation on the robot arm 201 side. The operating switch that causes the output shaft information recording mode to start can be arranged on the backside or the bottom of the base unit 210, for example. In such a case, the operating switch is formed of a push button switch operated by using a DIP switch, a pin arranged, or the like inside a cover or in a recess part.

Next, the CPU 381 detects angle information on the output shaft via the detection circuit 363 from the output-side encoder 236 of the robot arm 201 (step S2).

Next, the CPU 381 performs signal processing to convert a pulse signal of output shaft information into storable information by using the signal processing unit 385 (step S3). Furthermore, the CPU 381 records the converted output shaft information in the storage unit 386 (step S4). At this time, output information of the output-side encoder 236 (joint sensor) and clock information are stored in the storage unit 386 in association with each other in any manner as described above.

The angle information from the output-side encoder 236 is a pulse signal, and the signal processing unit 385 performs a process to convert the total number of pulses per rotation into information (1801) of (temporal change of) the joint angle as illustrated in FIG. 6, for example. Note that, in FIG. 6, the time on the horizontal axis (time) is represented in a unit of second, and the angle on the vertical axis is represented in a unit of degree (deg). The joint angle data per time converted in such a way is output for all the axes (six axes in the present embodiment) of the robot arm 201, and the data for all the axes is recorded (logged) in the storage unit 386 of the output shaft signal recorder unit 380.

Note that the motor 231 of the present embodiment is implemented with a brake (not illustrated), and since a brake works when the motor 231 is not powered, the motor angle does not change. Thus, the storage of the encoder 235 is not essential. When no brake is implemented to the motor 231, however, the motor 231 may rotate due to a load, and in such a case, recording in the encoder 235 is performed, output of both encoders or the difference thereof is recorded, and the load may be evaluated.

Subsequently, the CPU 381 of the output shaft signal recorder unit 380 (logging device) determines whether or not it is within a preset recording time period (step S5). This “recording time period” corresponds to a time length in which the output shaft information recording mode is allowed in the robot arm 201 and may be around several to several ten hours, for example. Since the “recording time period” is limited due to the storage capacity of the storage unit 386 or the capacitance of the battery unit 283, the “recording time period” of the output shaft information recording mode can be limited or set in advance in accordance with a measuring time period, for example, an expected transport period or the like in the present embodiment. Note that the value of the “recording time period” can be set from the robot control apparatus 300 side by using a suitable setup mode or the like. Further, a recording cycle or the like for joint information may be set manually or automatically in accordance with “recording time period”. Here, if it is within the “recording time period” (step S5, Yes), the CPU 381 repeats the process of steps S2 to S5 until a predetermined “recording time period” is reached. Note that a suitable timer circuit or the RTC device described above (not illustrated) can be used for measurement of the “recording time period”.

If the predetermined “recording time period” is reached in step S5 (step S5, No), the recording ends (step S6). Thereby, the output shaft information acquisition mode ends.

In the present embodiment, when the robot control apparatus 300 and the robot arm 201 are connected to each other after the robot arm 201 is caused to perform the output shaft information acquisition mode, the recorded output information of the joint sensor (the encoder 236 or 235) is caused to be extracted to the robot control apparatus 300 side. In the robot control apparatus 300, based on the read output information of the joint sensor (the encoder 236 or 235), load evaluation for respective joints (J1 to J6) can be performed.

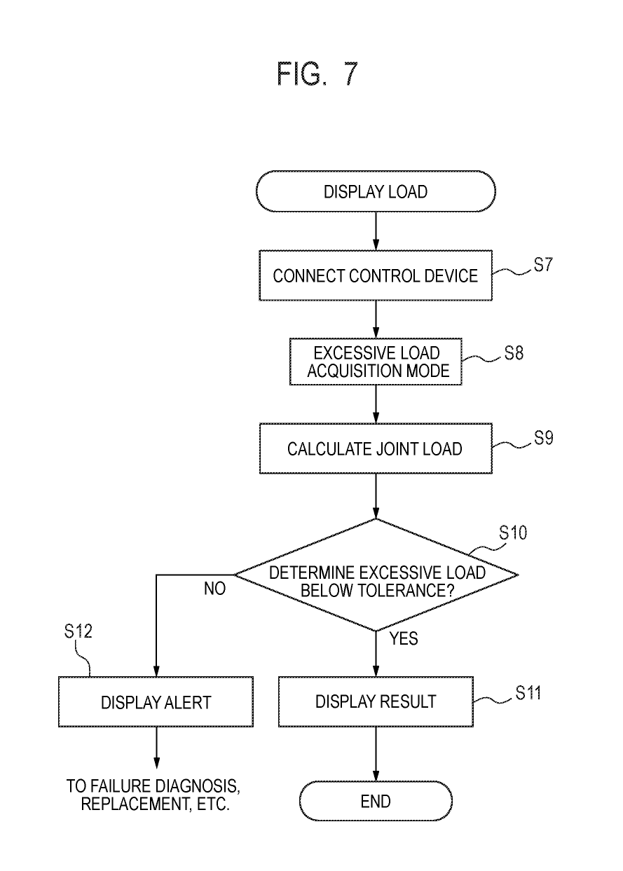

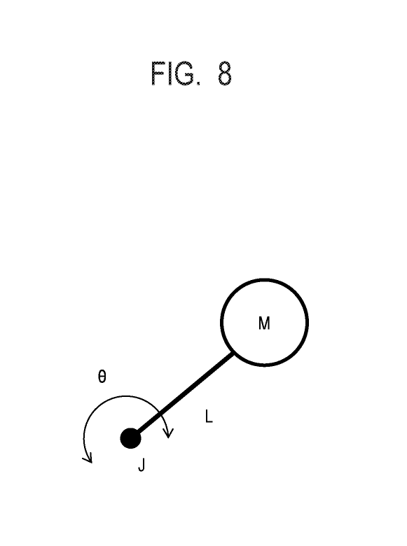

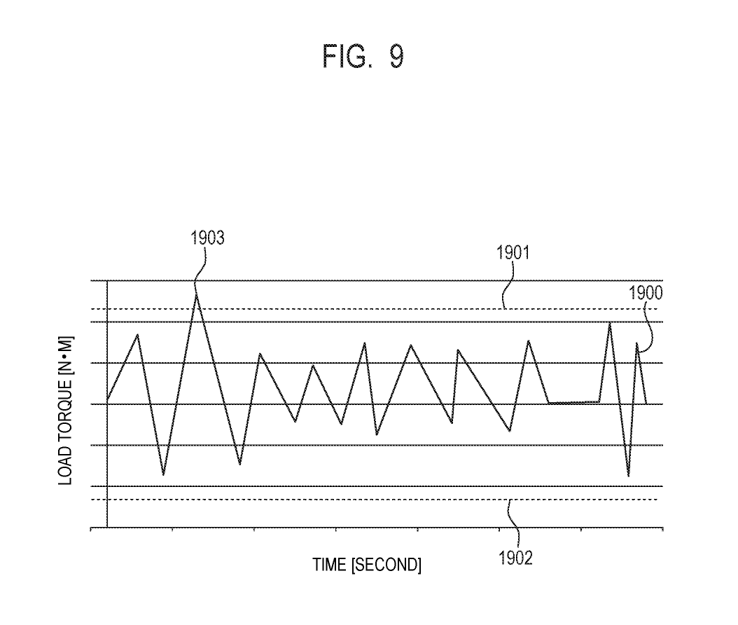

FIG. 7 illustrates a flow of extraction of the output information of the joint sensor (the encoder 236 or 235) recorded (logged) in the output shaft signal recorder unit 380 and acquisition (evaluation) of load information based thereon in the present embodiment. Further, FIG. 8 is a schematic diagram of a joint configuration, and FIG. 9 is a graph illustrating load fluctuation.

Once the robot control apparatus 300 is connected to the robot arm 201 (step S7 of FIG. 7), the robot system 100 enters an operating state. Next, in the load acquisition mode, the CPU 381 transmits the output shaft information stored in the storage unit 386 of the robot arm 201 to the load processing unit 390 of the robot control apparatus 300 (step S8).

Next, the load of each joint is calculated by the load calculation unit 391 of the load processing unit 390 of the robot control apparatus 300 by using a scheme illustrated in FIG. 8 (step S9). In FIG. 8, J represents the joint center, M represents inertia of a part extending from a joint, L represents the centroid position, and θ is a joint angle. Since the inertia and the centroid position change in accordance with design information and an attitude of the robot arm 201, the inertia and the centroid position are calculated at the same time as the load calculation. A load applied to a joint causes a rotation torque of the joint axis center. In calculation of a torque, a second order differential is performed on θ to derive an angle acceleration ω, a moment of inertia I is derived from the inertia M and the centroid position L, and then a load torque T is calculated by I×ω.

By performing such load torque calculation, it is possible to acquire temporal load torque data as illustrated in FIG. 9 based on output shaft information of a joint sensor. In the example of FIG. 9, the waveform of the load torque data 1900 is included inside the tolerance range (1901 to 1902) for a substantial period but exceeds the upper limit of the load (1901) at a peak part of 1903.

Next, the calculation result is transmitted to the excessive load determination unit 392, and if the load torque is within a preset tolerance range (1901 to 1902 in FIG. 9) in step S10 (step S10, Yes), the result is displayed, and the process ends (step S11). The tolerance value is restricted by the reducer 233 of each joint, which is a tolerance peak torque of the strain wave gearing reducer in the present embodiment. If the tolerance is exceeded (step S10, No), it is determined that a joint part is damaged, and thus an alert display is performed (step S12) to urge the user to perform failure analysis, replacement, or the like. In the example of FIG. 9, the load alert display of step S12 is performed at a peak part of 1903. According to a logging scheme of the present embodiment, since it is possible to determine the time when an excessive load occurs, it is possible to determine the timing when an excessive load occurs and analyze the event that has occurred by separately referencing a work time chart (an operation timetable in a case of being transported) or the like, for example.

Note that the process of load acquisition and evaluation and, alternatively or in addition, alert in steps S8 to S12 may be considered as a process of robot arm diagnosis that generates diagnosis information on a robot arm in accordance with an output data state of a joint sensor. This robot arm diagnosis may be not only to alert the excessive load but also to generate and output robot arm diagnosis information so as to specifically instruct the operator to perform any of inspection, examination, overhaul, part replacement, or the like in accordance with the level of the load torque value.

As described above, in the present embodiment, since load measurement is performed by the encoder 236 mounted on the robot arm 201, a special device such as an acceleration sensor is not required. Further, since the encoder 236 is mounted on each joint, there is an advantage of being capable of accurately acquiring a load of each joint and performing accurate (excessive) load determination (evaluation). In comparison to the scheme of using packing as disclosed in Japanese Patent No. 3366240, since output of a joint sensor of each joint of an arm can be directly logged according to the configuration of the present embodiment, the measurement accuracy can be significantly improved.

Moreover, in the present embodiment, the output shaft signal recorder unit 380 is provided inside the robot arm 201 separately from the robot control apparatus 300, and the output of a joint sensor of each joint can be logged in an arm alone. Therefore, information on the output shaft can be recorded also in a state where the robot control apparatus 300 is not connected, for example, in a non-operating state or during transportation or installation, and it is possible to reliably prove the presence or absence of an excessive load that may cause a failure.

### Second Embodiment

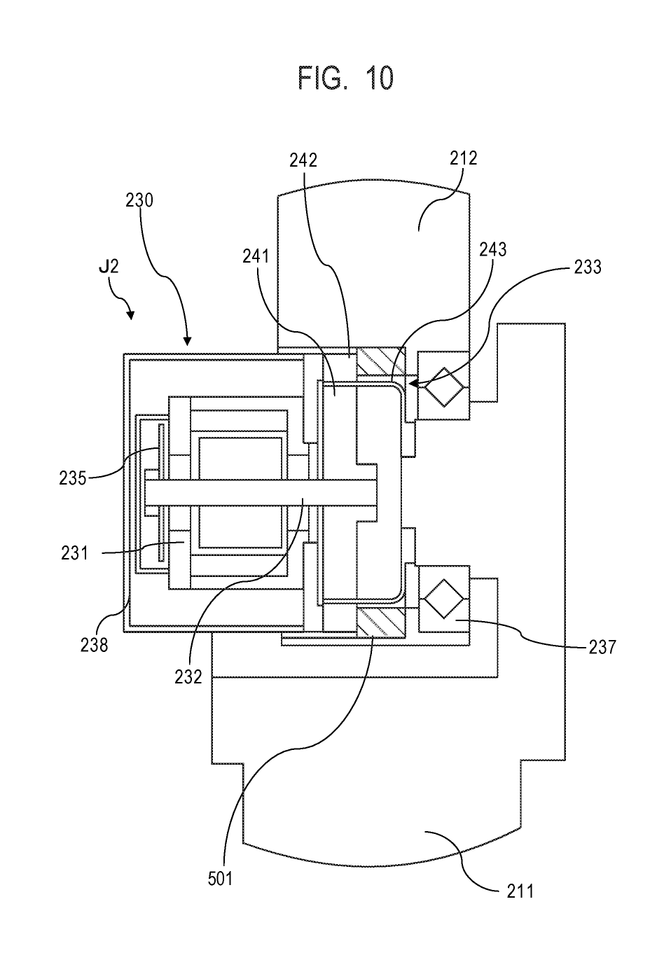

Next, a robot system according to a second embodiment of the present invention will be described by using FIG. 10 to FIG. 13. Note that a hardware configuration such as a portion not illustrated in FIG. 10 to FIG. 13, for example, the robot arm unit 200 or the like is the same as that in the robot system 100 of the first embodiment, and the detailed description thereof will be omitted if not particularly necessary. Further, each component in FIG. 10 to FIG. 13 that is the same as or corresponds to that in the first embodiment will be labeled with the same reference, and the detailed description thereof will be omitted.

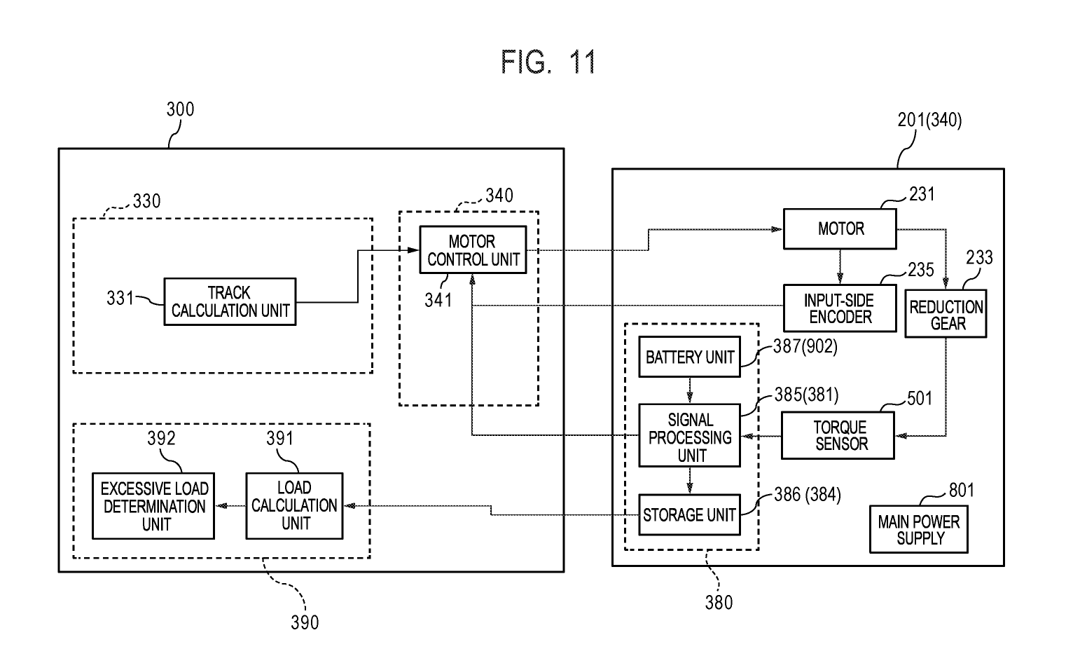

FIG. 10 corresponds to FIG. 2 of the first embodiment and is a partial sectional view illustrating the joint J2 of the robot arm 201 of the present embodiment, and FIG. 11 corresponds to FIG. 4 of the first embodiment and is a function block diagram illustrating a primary configuration of the robot system of the present embodiment, in particular, the function of the control system thereof.

In the first embodiment, the encoder 236 (joint angle detection unit) that measures the output shaft angle is used as a joint sensor that detects the state of a joint. In contrast, as illustrated in FIG. 10, a torque sensor 501 (force sensor) as a joint sensor is mounted in the joint (J2) in the present embodiment. The torque sensor 501 can be formed of an elastic member that displaces in response to a torque being applied and a displacement meter or a distortion gate that measures the displacement. The torque sensor 501 is arranged between the output side of the reducer 233 and the link 212 to detect the torque applied to the output shaft of the same joint. For other joints (J1 and J3 to J6), the same configuration as that in FIG. 10 can be implemented.

In the present embodiment, with the torque sensor 501 being arranged on the output side of the reducer 233 of a joint, the force applied to the output shaft of the joint can be detected. For example, when the operating load on the workpiece (W2, W1) is limited or the like, the torque of each joint of the robot arm 201 can be controlled. This enables robot control such as control so that the operating load on the workpiece (W2, W1) does not exceed a tolerance value.

In the control system, as illustrated in FIG. 11, the signal processing unit 385 reads the output of the torque sensor 501 instead of the encoder (236 in FIG. 4). Also in the present embodiment, output information of the joint sensor, that is, the torque value output by the torque sensor 501 is recorded (logged) in the storage unit 386 (the RAM 384 or the EEPROM 382) in association with clock information.

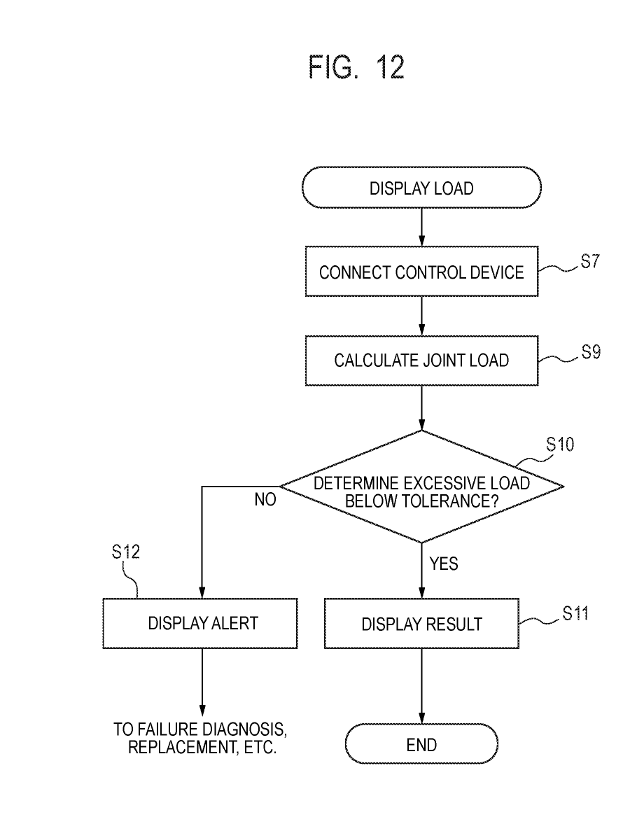

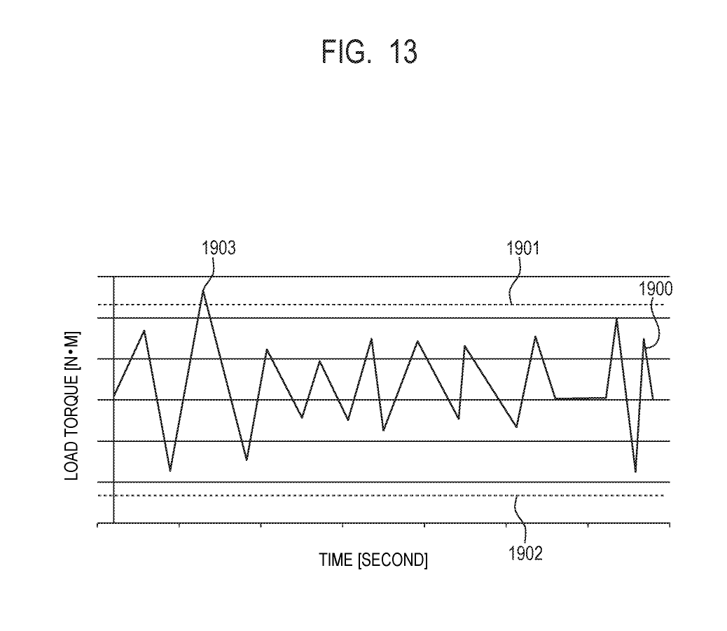

A logging (recording as a log) process of the output information (output shaft information) of the joint sensor (the torque sensor 501) of the robot arm 201 of the present embodiment can be performed as illustrated in FIG. 12 and FIG. 13. FIG. 12 is a flowchart illustrating a load indication (evaluation) procedure corresponding to FIG. 7 of the first embodiment, and FIG. 13 is a graph of the output shaft information (load fluctuation) corresponding to FIG. 9 of the first embodiment.

As is clear from the comparison of FIG. 7 and FIG. 12, since the torque sensor 501 is mounted as a joint sensor in the present embodiment, the process of converting the joint angle information of the encoder into a joint load (step S8 of FIG. 7) is unnecessary in the procedure in FIG. 12. Since other process steps can be performed in the same manner as described using FIG. 7, the duplicated description will be omitted here. In the present embodiment, fluctuation of the torque value on the output side of the joint is directly associated with clock information and recorded (logged) in the storage unit 386 (the RAM 384 or the EEPROM 382) on the robot arm 201 side. Thus, on the robot control apparatus 300 side, it is possible to acquire temporal fluctuation data in the load torque as illustrated in FIG. 13 by simply reading log information from the storage unit 386 (the RAM 384 or the EEPROM 382). In FIG. 13, a case where a load torque is recorded by using the torque sensor 501 in the example of FIG. 9 is expected, the load torque fluctuation of FIG. 13 indicates substantially the same change as that in FIG. 9. For example, the load torque of the joint exceeds the tolerance range at the peak position of 1903, and in response, a load torque alert (step S12 in FIG. 12) is performed also in the present embodiment.

As described above, in the present embodiment, since load measurement is performed by the torque sensor 501 mounted on the robot arm 201, no process such as joint angle-to-torque conversion calculation is required. Further, the torque sensor 501 mounted on a joint for robot control can be used to accurately acquire a load of the joint, which provides an advantage of being capable of performing accurate (excessive) load determination (evaluation). In comparison to the scheme of using packing as disclosed in Japanese Patent No. 3366240, since output of a joint sensor of each joint of an arm can be directly logged also in the present embodiment, the measurement accuracy can be significantly improved.

### Third Embodiment

In the present embodiment, modified examples in which a part of the configuration of the first or second embodiment described above is changed will be described. In each of the embodiments described above, a joint load is acquired and evaluated based on log information acquired from the arm side by the robot control apparatus 300 after the arm is connected to the robot control apparatus 300 after a logging operation (an output shaft information acquisition mode) is performed at the robot arm 201.

However, the robot arm 201 may be configured to alone analyze the logged information to detect an excessive load state and perform an alert process, for example. To this end, the display 905 of FIG. 1 is arranged on the robot arm 201 as display means for an alert process. In the example of FIG. 1, the display 905 is arranged on the side face of the base portion 210. As a joint sensor, an encoder may be used as with the first embodiment, or the torque sensor 501 may be used as with the second embodiment.

Further, to perform acquisition and evaluation of a joint load on (only) the robot arm 201 side, the acquisition and evaluation process of the joint load in steps S7 to S11 of FIG. 7 and FIG. 12 is configured as a control program of the CPU 381 of the output shaft signal recorder unit 380. This control program is then stored in a part of the program (383) of the EEPROM 382 (FIG. 3), for example.

The output shaft signal record mode (logging) can be performed in a similar manner to the above as illustrated in FIG. 5 (the first embodiment). The acquisition and evaluation process of the joint load (steps S7 to S11 of FIG. 7 and FIG. 12) is automatically performed by the CPU 381 of the output shaft signal recorder unit 380 after a predetermined “recording time period” has elapsed and the output shaft signal record mode ends, for example. Alternatively, the acquisition and evaluation process of the joint load (steps S7 to S11 of FIG. 7 and FIG. 12) may be performed in parallel to the output shaft signal record mode (FIG. 5), and the alert process (step S12 of FIG. 12) may be performed in substantially real time when the excessive load occurs.

The excessive load alert may be to turn on or blink an alert color (for example, red or the like) by using the display 905 (FIG. 1) arranged on the robot arm 201. In addition, with a speaker or the like being arranged in the robot arm 201, an excessive load alert can be performed by outputting an alert beep sound, an alert (synthetic) voice, or the like.

As discussed above, the robot arm 201 is configured to alone analyze logged information to detect an excessive load state and perform an alert process, for example. Thereby, in a state where the robot arm 201 is not connected to the robot control apparatus 300, for example, during transportation or the like, it is possible to detect an excessive load state of a joint and perform an alert process without the robot control apparatus 300.

Further, the configuration illustrated in the first and second embodiments can be utilized to record (log) joint information even in a state where the robot arm 201 is physically connected to the robot control apparatus 300. For example, joint information can be recorded (logged) in a period in which a main power supply (801) that powers a drive source (the motor 231) of joints (J1 to J6) is shut off, such as in close of work hours at nighttime after the robot system 100 is installed. The output shaft signal recorder unit 380 can perform control so as to start an output shaft signal record mode (logging) at the time when the main power supply is turned off based on voltage detection of the main power supply (801 in FIG. 3, FIG. 4, and FIG. 11) or the like. Load acquisition (or evaluation) performed by the robot control apparatus 300 can be performed as a part of an initialization process which is performed when the main power supply is again turned on, for example. With such a configuration, even when an unintended excessive load is applied to the joint in a period where the robot control apparatus 300 is unable to be involved such as close of work hours at nighttime, it is possible to reliably detect such an event and perform an alert process.

Further, the output shaft signal recorder unit 380 may be configured to log output information of both the encoder 235 or 236 and the torque sensor 501 illustrated in the first and second embodiments, respectively. In such a case, by combining the output information of the encoder and the output information of the torque sensor, it is possible to perform more various load analysis (acquisition), load evaluation, or diagnosis processing.

According to the configuration described above, a joint sensor that detects a state of a joint is provided to a robot arm, and output information from the joint sensor can be logged (recorded as a log) by being powered by a powering unit even in a state where a main power supply is shut off. Thus, without connection to the robot control apparatus that is a main controller, a robot arm can alone log information on a state of the joint of the arm thereof. It is therefore possible to record information on an output shaft during a non-operating period such as transportation or installation and reliably prove the presence or absence of an excessive load which may cause a failure.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A robot arm comprising: a plurality of links; a joint connecting the plurality of links to each other; and a sensor that detects a state of the joint, the robot arm further comprising:
a logging device that records output information of the sensor; and
a powering unit that supplies power to the sensor and the logging device in a state where a drive power supply of the joint is shut off

2. The robot arm according to claim 1, wherein the logging device records the output information of the sensor in association with clock information.

3. The robot arm according to claim 1, wherein the logging device records the output information of the sensor by being powered by the powering unit in a state where a robot control apparatus comprising a control unit that controls the joint of the robot arm and the robot arm are disconnected from each other.

4. The robot arm according to claim 1, wherein the sensor is an encoder that measures a joint angle at which the link is coupled by the joint.

5. The robot arm according to claim 1, wherein the sensor is a force sensor that detects force applied to the joint.

6. A robot control apparatus comprising:
a control unit that controls the joint of the robot arm according to claim 1; and
a log acquisition device that acquires log information recorded by the logging device.

7. The robot control apparatus according to claim 6, wherein the control unit generates diagnosis information on the robot arm in accordance with the log information acquired by the log acquisition device.

8. A non-transitory computer readable storage medium in which a control program of a robot arm is stored, the control program causing the logging device of the robot arm according to claim 1 to record the output information of the sensor.

9. A non-transitory computer readable storage medium in which a control program of a robot control apparatus is stored, the control program causing the control unit of the robot control apparatus according to claim 7 to generate the diagnosis information on the robot arm.

10. A robot system comprising:
a robot arm comprising a plurality of links, a joint connecting the plurality of links to each other, a sensor that detects a state of the joint, a logging device that records output information of the sensor, and a powering unit that supplies power to the sensor and the logging device in a state where a drive power supply of the joint is shut off; and
a robot control apparatus comprising a control unit that controls the joint of the robot arm and a log acquisition device that acquires log information recorded by the logging device.

11. The robot system according to claim 10, wherein the control unit generates diagnosis information on the robot arm in accordance with the log information acquired by the log acquisition device and performs robot arm diagnosis based on the diagnosis information.

12. The robot system according to claim 10, wherein the logging device comprises a storage device that records the output information of the sensor and clock information in association with each other.

13. The robot system according to claim 10, wherein in a state where the robot control apparatus and the robot arm are disconnected from each other, the logging device performs a logging operation to record the output information of the sensor by being powered by the powering unit.

14. The robot system according to claim 10, wherein the sensor is an encoder that measures a joint angle at which the link is coupled by the joint.

15. The robot system according to claim 10, wherein the sensor is a force sensor that detects force applied to the joint.
